(19) United States
(12) Patent Application Publication
(10) Pub. No.: US 2010/0217572 A1
(43) Pub. Date: Aug. 26, 2010

(54) METHOD AND DEVICE FOR AUTOMATIC PATTERN RECOGNITION

(75) Inventors: Clemens Guhmann, Berlin (DE); Steffen Kuhn, Werder (DE)

Correspondence Address: SCHMEISER, OLSEN & WATTS, 22 CENTURY HILL DRIVE, SUITE 302, LATHAM, NY, 12110, US

(73) Assignee: TECHNISCHE UNIVERSITAT BERLIN, Berlin (DE)

(21) Appl. No.: 12/671,248

(22) PCT Filed: Jul. 31, 2008
(86) PCT No.: PCT/DE08/01256

§ 371 Date: May 3, 2010

(30) Foreign Application Priority Data
Jul. 31, 2007 (DE) 102007036277.5
Jul. 31, 2008 (DE) PCT/DE08/001256

(51) Int. Cl. G06F 17/10; G06N 5/02; G06F 15/18

(52) U.S. Cl. 703/2; 706/48; 706/12

(57) ABSTRACT

The invention relates to a method for the automatic pattern recognition in a sequence of electronic data by means of a electronic data processing in a data processing system, during which the sequence of electronic data is compared with parameterised model data representing at least one sample sequence, in an analysis and where at least one sample sequence is recognised if training data is processed to a set of characteristic vectors of the same length and with the same information content, from which the parameterised model data is derived, by means of a dynamic time warping method during the formation of the parameterised model data, if it has been established during the analysis that the model data enclosed by the parameterised model data, which are allocated to at least one sample sequence, occurs with a level of similarity exceeding the similarity threshold. In addition, the invention relates to a device for automatic pattern recognition in a sequence of electronic data by means of electronic data processing with a data processing system.

The invention relates to a method and a device for automatic pattern recognition in a sequence of electronic data by means of electronic data processing by a data processing system.

### BACKGROUND OF THE INVENTION

In general, it is the aim of such pattern recognition to trace the occurrence of sequences or successions of features in sequentially formed electronic data. The patterns to be found cannot be defined in many practical applications, because they can vary in their form and their extent. The problem of speech recognition by machine can be cited as an example, because fundamental standard methods have been developed from the state of the art in the context of this task. An additional use concerns the discovery of incorrect patterns in mechanical signals. This includes, for example, the recognition of knocking combustion in petrol engines by means of structure-borne signals, where a similar problem arises (Lachmann et al.: Erkennung klopfender Verbrennungen aus gestörten Klopfsensorsignalen mittels Signaltrennung, Sensorik im Kraftfahrzeug, Expert Verlag, 114-123). The method developed is also necessary during the search for incorrect patterns in vehicle CAN Bus data, for example (Isernhagen et al.: Intelligent signal processing in an automated measurement data analysis system. In Proceedings of the 2007 IEEE Symposium on Computational Intelligence in Image and Signal Processing (CHSP 2007), Pages 83-87, 2007) or during the comparison of actual and theoretical value sequences when checking specifications (Rebeschielβ et al.: Automatisierter closed-loop-Softwaretest eingebetteter Motorsteuerfunktionen, 11. Software & Systems Quality Conferences 2006, 7. ICS Test, 2006).

The Hidden Markov Models (HMM) have established themselves as the solution to the problem of sequence classification and represents the state of the art in the sector of speech recognition (Gernot: Mustererkennung mit Markov-Modellen, Teubner, 2003). Here, the fundamental idea exists in describing a sequence or result as the result of a chain of probable assessments of density. The transition from a distribution to subsequent distributions is also modelled statistically. HMMs are described as two-stage stochastic processes within the framework of pattern recognition for this reason. They are really efficient, but they have disadvantages.

The classification and recognition of sequences or successions are apparently differentiated in principle from conventional pattern recognition tasks where the feature vectors of a fixed dimension are analysed Such methods and devices for pattern recognition are known from the documents DE 694 25 166 T2, DE 697 04 201 T2 and DE 10 2006 045 218 A1, for example, and comprehensively from the specialist literature, apart from this (compare Duda et al.: Pattern Classification, John Wiley & Sons, 2000, for example). They all have in common that they are based on the estimation of a probable allocation per class or on the estimation of class limits at least. HMMs are clearly different; this is necessitated by the diversity of the data structures to be analysed. HMMs analyse sequences, that is, the successions of features, values, symbols or vectors. A problem exists here in that the pattern sequences or successions usually vary in length, where two pattern sequences or successions different in length can belong to the same class. Sequences are therefore not vectors; this means that no feature space exists and no probable allocation can be established. The use of classifiers based on feature vectors is prevented by this.

The approach to a solution by HMMs consists in that an observed O={xₗ, . . . , xₙ} sequence—specified in the specialist term of the HMM observation sequence—represents a succession of the S₁, S₂, . . . , Sₘ chance variables. This implies an additional hidden stage, because a deterministic allocation of an exact observation xₜ with t ε [l,n], to a chance variable S_{τ} with τ ε [l,m], is not possible. It is described by a stochastic process modelling the transition from a state variable to a different variable by probable transitions, for this reason. Account has been taken of the special form of the data with this. However, some disadvantages also result from this architecture, because the two-stage process obviously increases the complexity in comparison to classifiers based on feature vectors. The model parameters must be optimised numerically for this reason; this does not always necessarily lead to good parameter values on the one hand and is also expensive.

A further limitation of HMMs consists in the fact that they are parametric models. This means that they prescribe a restricting framework that does not always have to fit the data. Parametric models are often affected by over- and underfitting for this reason. As an example, it is indicated that HMMs basically require that the Markov characteristic is fulfilled. Another example is assumption of the temporal invariance within a state. Both assumptions are generally never completely fulfilled; this results in a basically structurally conditioned underfitting.

A pattern recognition method that is employed to recognise feature sequences, actually with speech recognition, is described in DE 697 11 392 T2. An additional area of application of the pattern recognition of patterns or feature sequences concerns the recognition of knocking in connection with engines. This is dealt with in the following.

Knocking combustion is an undesirable deviation from normal combustion. Normal combustion is triggered by the sparks of the ignition plugs and is associated with a moderate increase in pressure in the cylinder. In contrast, knocking combustion creates high pressure peaks and can lead to damage to the engine. It frequently occurs if ignition takes place too early. Later ignition can help, but it will lead to a reduction in engine performance and therefore to an increase in fuel consumption. It is sensible to select the time of ignition so precisely that no knocking occurs, for this reason. An adjustment, dependant on knocking, to the ignition time is necessary, because the inclination of an engine to knock depends on external influences. A reliable recognition of knocking combustion is indispensable for this.

In principle, knocking combustion can be determined by means of the march of pressure inside the cylinder. However, sensors to record the measured quantity are expensive and wear out quickly, so that other sensing elements must be used for sequential operation. Sensors measuring structure-borne noise attached to the engine block are good value and supply indirect information about the combustion taking place inside the engine. Knocking combustion an be detected by means of noise peaks in particular. The advantages of the use of structure-borne noise instead of the pressure are won with a more complicated evaluation more susceptible to errors, because other effects can also become apparent in the structure-borne noise.

Digital filters to recognise frequencies typical of knocking (compare DE 101 38 110 A1) or simple classifiers based on feature vectors (compare DE 103 52 860 A1) on the basis of particular feature values or features gained by averaging, integration or a similar process (compare EP 1 309 841 B1 or EP 1 184 651 A2) are known for the detection of knocking combustion by means of structure-borne noise signals. Such methods are susceptible to errors in principle, because a lot of relevant information, particularly temporal dependencies, is usually lost during the formation of features. This disadvantage is said to be lessened by means of the formation of time windows in document DE 103 00 204 A1. The structure arising then can be interpreted as a simple state automaton.

Other methods attempt to create a virtual pressure signal with the help of the structure-borne noise signal. For example, a neural network is used for this in document DE 197 41 884 C2. Neural networks are, however difficult to use and do not always lead to reproducible results, because many parameters (network structure, transfer functions) are pre-determined a priori in advance. The place values of the network have to be optimised numerically with effort, though only sub-optima are often found.

HMMs are an alternative approach. Here, the temporal and spectral variability of the signals are described in the form of a stochastic automaton, on the basis of a given set of sample or training data. The actual structure-borne noise signals are converted to time intervals of spectral vectors by means of STFT (short-time Fourier transform) for this. The temporal pattern of the spectral vectors, the feature sequences, can be modelled by an HMM.

HMMs can only be used for recognising knocking conditionally, in spite of their suitability in principle, because HMMs are able to model short sequences, preferably short, non-stochastic sequences, only relatively poorly, because of the communicative characteristics of the statuses. They exhibit similar disadvantages to neural networks in addition.

### SUMMARY OF THE INVENTION

It is an object of the invention to provide a method and a device for automatic pattern recognition in a sequence of electronic data, with which a reliable recognition of patterns in the sequence of electronic data is workable in a simplified way, by means of electronic data processing in a data processing system.

The object is solved by a method for automatic pattern recognition in accordance with the independent Claim 1 and a device for automatic pattern recognition in accordance with the independent Claim 5, in accordance with the invention.

The invention comprises the idea of a method for automatic pattern recognition in a sequence of electronic data by means of electronic data processing in a data processing system, during automatic pattern recognition in a sequence of electronic data by means of electronic data processing in a data processing system, where the sequence of electronic data is compared with parameterised model data representing at least one pattern sequence in an analysis and where at least one pattern sequence will have been recognised, if it has been established during the analysis that the model data allocated to at least one pattern sequence included in the parameterised model data occurs with a level of similarity exceeding the similarity threshold, where training data is processed to a set of feature vectors of the same length and with the same information content as the training data, from which the parameterised model data will be derived by means of a dynamic time warping method, during the formation of the parameterised model data.

A device for automatic pattern recognition in a sequence of electronic data created by a data processing system by means of electronic data processing, having the following characteristics, is created in accordance with an additional aspect of the invention:
pattern recognition means configured to compare the sequence of electronic data with parameterised model data representing at least one pattern sequence in an analysis and to recognise at least one pattern sequence, if it has been established during the analysis that the model data allocated to at least one pattern sequence and included in the parameterised model data occurs with a level of similarity exceeding the similarity threshold, and
model data creation means configured to create the parameterised model data using training data and to process the training data to a set of feature vectors of the same length and with the same information content as the training data, from which the parameterised model data are derived, at the same time, by means of a dynamic time warping method, and
provision means configured to provide electronically analysable identifying information concerning the recognition of at least one pattern sequence for an output.

It has been achieved that a comparison of components is possible during the sample recognition to a set of feature vectors of the same length and with the same information content as the training data using a dynamic time warping method, with the aid of the conversion of the training or sample data (Myers et al.: A comparative study of several dynamic time-warping algorithms for connected word recognition. The Bell System Technical Journal, 60(7):1389-1409, September 1981). Sequences or successions that vary in length do not permit this. Feature vectors of a fixed dimension and with the same information content as the training or sample data arise in this way. The conversion to feature vectors with the same information content means that a reconstruction of the training data from the feature vectors is possible without additional information. Temporal distortion information specific to the training data is retained especially. A set of feature vectors that can be subsequently evaluated by means of any classic classifier based on feature vectors will then exist. The problem of pattern recognition is attributed to such a familiar classification task. No two-stage stochastic processes, as is the case in the case of HMMs, are needed.

A preferred development of the invention provides that the parameterised model data are derived from the set of feature vectors, because a classifier based on feature vectors is parameterised.

It can be provided that a Bayesian classifier with Kernel window density evaluation is used as the classifier based on feature vectors, in the case of a functional development of the invention.

A convenient development of the invention provides that the level of similarity for a partial sequence of electronic data from the sequence of electronic data investigated for a time j of the analysis is determined as follows:

$$L ( i , j ) := {max}_{α = 0 , {…α}_{m} - 1} \{ L ( i - 1 , j - α ) + log ( {p}_{t , i} ( α ) ) \} + c log ( {p}_{e , i} ( {x}_{j} ) )$$

Where xⱼ, p_{t,i}(·) and p_{e,i}(·), the elements of the sequence of electronic data, the i elements of all N elements of parameterised model data, and c and aₘ are constants to be selected empirically. The level of similarity looked for at that time is L(N,j).

The method can be used for automatic pattern recognition in connection with different technologies to which mechanized signal analysis, such as an analysis of knocking in the case of an engine, the signal analysis of ECG signals, speech recognition, analysis of a gene sequence, the image analysis and the evaluation of heat image data, for quality control in the case of mechanically forged components, belong in particular. Then, the respective data to be analysed and sample and training data, in an electronic form, and the corresponding representative quantities for measuring or analysis will be present.

### DESCRIPTION OF THE PREFERRED EXAMPLES OF EMBODIMENTS OF THE INVENTION

The invention is explained in closer detail in the following by means of examples of embodiments, with reference to the Figures. They are as follows:

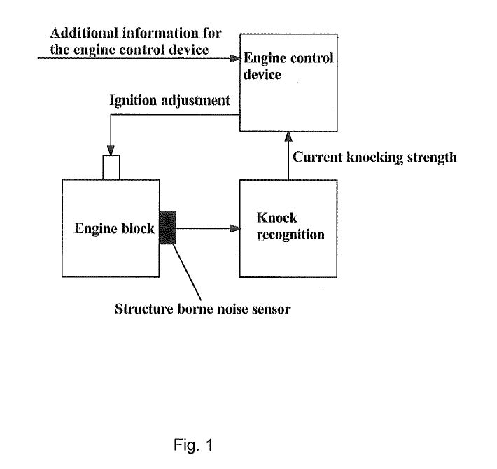

FIG. 1 A schematic representation of the structure of a knocking control for an engine,

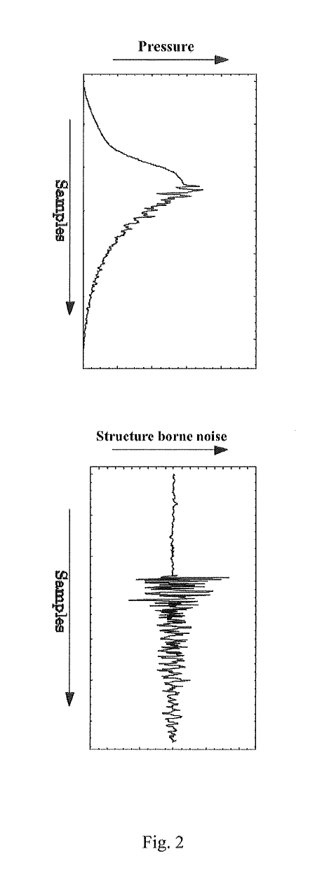

FIG. 2 An example of the data to be processed in the case of a knocking control and

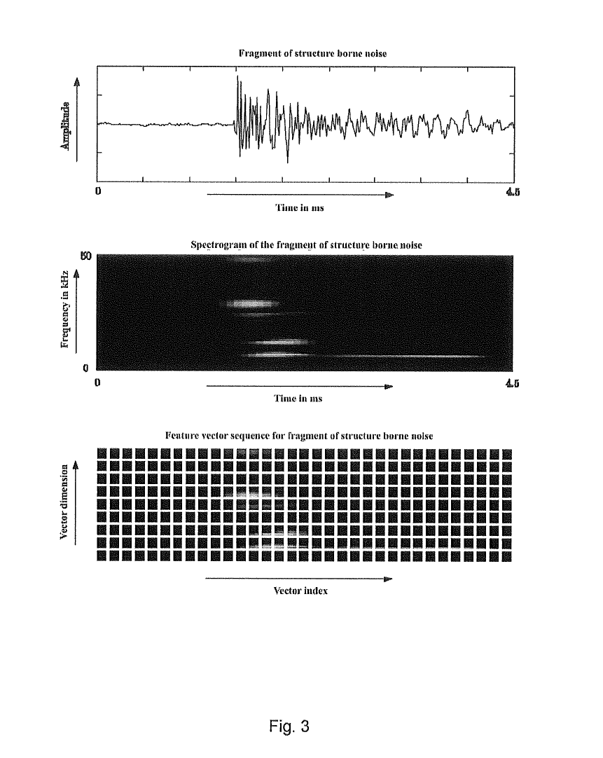

FIG. 3 A schematic representation describing the connection between measured sound-borne noise signals and electronic data arranged in sequence.

The method for pattern recognition comprises three partial aspects that can be regarded separately, namely (i) a data set transformation, (ii) a determination of the parameters of a model and (iii) the application of the parameterized model to recognise sequences or successions in electronic data arranged in sequence that can represent different information content for its part.

A transformation of a set of sample or training data into feature vectors takes place in a first step, thus allowing access to hidden random variables and a direct comparability. It shall be assumed that three training or sample sequences are available for establishing the parameters:

S₁={a,a,b,b,b,d,d,d,e,f,g}

S₂={a,a,a,b,b,c,c,d,d,e,e,f,f,f,g,g}

S₃={a,b,b,b,c,d,d,e,f,f,g,g}. (1)

Sequences of symbols are used to keep the explanation simple. However, real numbers or vectors can also be used instead of symbols. Only one comparative criterion will then be needed for this: for example, the absolute sum of the difference in the case of real numbers and a distance measurement, such as the Euclidian distance, in the case of vectors. The comparative criterion has degenerated, in the case of symbols, to the extent that the distance is zero if two symbols are equal; otherwise the distance is one.

The set of sample or training data respectively represent electronic analysable information about one or several samples of measurable quantities that are to be recognised later in the different cases of application.

It must be recognised that the three sequences (1) contain non-linear distortions. They can be compensated. Equalization produces:

S₁={a,a,*,b,b,b,*,*,d,d,d,e,*,f,*,*,g,*}

S₂={a,a,a,b,b,*,c,c,d,d,*,e,e,f,f,f,g,g}

S₃={a,*,*,b,b,b,c,*,d,d,*,e,*,f,f,*,g,g}. (2)

Stars indicating a necessary repetition of the previous symbol are inserted, so that the sequences will be equal. No complete equality can be achieved by means of equalization in the case of sequences of real numbers or vectors. However, ah equalization that minimizes the distance between the sequences can always be found here. The dynamic time warping method is a method that performs this.

The necessary extensions per sample sequence can be described with the help of the binary vectors

δ₁={1,1,0,1,1,1,0,0,1,1,1,1,0,1,0,0,1,0}

δ₂={1,1,1,1,1,0,1,1,1,1,0,1,1,1,1,1,1,1}

δ₃={1,0,0,1,1,1,1,0,1,1,0,1,0,1,1,0,1,1}, (3)

which always contain a one if a symbol was present at this position in the original sequence.

Otherwise, the entry is zero. The corrected sequences (2) and the distortion vectors (3) are combined into

m′₁={a,a,*,b,b,b,*,*,d,d,d,e,*,f,*,*,g,*,1,1,0,1,1,1,0,0,1,1,1,1,0,1,0,0,1,0}

m′₂={a,a,a,b,b,*,c,c,d,d,*,e,e,f,f,f,g,g,1,1,1,1,1,0,1,1,1,1,0,1,1,1,1,1,1,1}

m′₃={a,*,*,b,b,b,c,*,d,d,*,e,*,f,f,*,g,g,1,0,0,1,1,1,1,0,1,1,0,1,0,1,1,0,1,1}

The star symbols can be replaced by the previous symbols here without loss of information, because an inverse transformation by the attached binary vectors would always be possible, and the following feature vectors will arise

m₁={a,a,a,b,b,b,b,b,d,d,d,e,e,f,f,f,g,g,1,1,0,1,1,1,0,0,1,1,1,1,0,1,0,0,1,0}

m₂={a,a,a,b,b,b,c,c,d,d,d,e,e,f,f,f,g,g,1,1,1,1,1,0,1,1,1,1,0,1,1,1,1,1,1,1}

m₃={a,a,a,b,b,b,c,c,d,d,d,e,e,f,f,f,g,g,1,0,0,1,1,1,1,0,1,1,0,1,0,1,1,0,1,1}. (4

It will be noticed that the front halves of the vectors are almost the same. However, this effect only arises in the case of sequences of symbols. The entries will merely be similar in the case of symbols of real numbers or vectors. The decisive advantage of this data set transformation exists in the fact that the distortions hidden in the training data become explicit and that feature vectors will have arisen. Otherwise, the information about distortion will, however, be the same in the original training data and in the feature vectors created. A comparison of components will now be possible as a result. Sequences that vary in length do not permit this.

The determination of the parameters of the model will take place in the following partial aspect.

A probability density p(m) can be estimated with the help of the set of sample or training data (4). This will describe the structure and randomness of the data, in both time and amplitude. A Kernel approach, for example, a Parzen approach, can be used to model the probability density (Parzen: On estimation of a probability density and mode. Annals of Mathematical Statistics, Vol. 33: 1065-1076, 1962):

$$\tilde{p} ( m ) \approx \frac{1}{n} {\sum }_{k = 1}^{n} φ ( m - {m}_{k} , s ) with φ ( m , s ) = {\prod }_{i = 1}^{d} \frac{1}{\sqrt{2 π {s}_{i}}} exp \{ \frac{{m}_{i}^{2}}{2 {s}_{i}} \} . \qquad ( 5 )$$

Here, n is the number of feature vectors, d is the dimension of the feature vectors, s=(sₗ, . . . , sₙ)^{T} is a smoothing parameter to be estimated and mₖ=(mₖₗ, . . . mₖₙ)^{T} is the k feature vector of the data set. The only open parameter s can be determined with the help of a fixed point algorithm so that the ability of the density estimate \tilde{p}(m) to predict is at a maximum (Duin: On the choice of the smoothing parameters for parzen estimators of probability density functions. IEEE Transactions on Computers, Vol. C-25, No. 11: 1175-1179, 1976).

Gaussen functions like this, φ(m−mᵢ,s) and φ(m−mⱼ,s), will subsequently be brought together with i≠j to a single Gaussen function a′ᵢφ(m−m′ᵢ,s′ᵢ), the similarity of which is high enough, in order to reduce the quantity of data. The new a′ᵢ, s′ᵢ and m′ᵢ parameters will appear at the same time because of the transformation. The resulting model for the distribution after the bringing together is

$$\tilde{p} ( m ) \approx \frac{1}{n} {\sum }_{k = 1}^{n} {a}_{k}^{′} φ ( m - {m}_{k}^{′} , {s}_{k}^{′} ) , \qquad ( 6 )$$

where q can be much lower than n. The formulas for the a′ᵢ, s′ᵢ and m′ᵢ parameters are

$${a}_{i}^{′} = {a}_{i} + {a}_{j} , \\ {m}_{i}^{′} = \frac{{a}_{i} {m}_{i} + {a}_{j} {m}_{j}}{{a}_{i} + {a}_{j}} and {s}_{i}^{′} = \frac{{a}_{i} {{a}_{j} ( {m}_{i} - {m}_{j} )}^{2}}{{( {a}_{i} + {a}_{j} )}^{2}} + \frac{{a}_{i} {s}_{i} + {a}_{j} {s}_{j}}{{a}_{i} + {a}_{j}} . \qquad ( 7 )$$

The expression (mᵢ−mⱼ)² is to be understood in terms of components here, i.e., each component of the vector mᵢ−mⱼ will be bought to the second power individually. sᵢ=s and aᵢ=1 will apply to all i=1, . . . , n before the bringing together.

$$D = \frac{1}{d} {\sum }_{k = 1}^{d} \frac{{( {s}_{ik} - {s}_{jk} )}^{2} + {( {m}_{ik} - {m}_{jk} )}^{2} ( {s}_{ik} - {s}_{jk} )}{{s}_{ik} {s}_{jk}} . \qquad ( 8 )$$

is suitable as the criteria for the similarity of the two Gaussen functions φ(m−mᵢ,sᵢ) and φ(m−mⱼ,sⱼ).

The model \tilde{p}(m) of the probability distribution consists of a sum of q Gaussen distributions φ(m−m′ₖ,s′ₖ) weighted with the a′ₖ factors, with k=1, . . . , q, after the compression. The vector dimension d can than be reduced in the same way.

Each of the φ(m−m′ₖ,s′ₖ) q Gaussen functions that has arisen is a specialist for a partial section of the data and consists of the product of scalar Gaussen functions. Here, the scalar Gaussen functions model either a local probable density at the time or in the amplitude, according to the components of the feature vector m, which consists of a sequence S and a binary distortion vector δ. Each of the q Gaussen functions

$$φ ( m - {m}_{k}^{′} , {s}_{k}^{′} ) = {\prod }_{i = 1}^{d} \frac{1}{\sqrt{2 π {s}_{ik}^{′}}} exp \{ \frac{{( {m}_{i} - {m}_{ki}^{′} )}^{2}}{2 {s}_{ki}^{′}} \} \qquad ( 9 )$$

can be interpreted as

$$φ ( m - {m}_{k}^{′} , {s}_{k}^{′} ) = {\prod }_{i = 1}^{N} {p}_{e , i} ( x ) \cdot {p}_{t , i} ( δ ) , \qquad ( 10 )$$

after the feature vector coding has been cancelled. Here the sections of s′ₖ and m′ₖ that stem from the distortion vector δ determine the parameters for the transition densities p_{t,i}(δ) and the sections that stem directly from the sequence S determine the parameters for the emission densities p_{e,i}(x). The emission densities and the transition densities are merely the factors of the product (9) in a recoded form. The parameterizing phase is ended with this. The following section describes how the model can be used efficiently.

Now, the partial aspect concerning the application of the model for actual pattern recognition follows.

A sequence S will be investigated as to whether patterns occur that are similar to the sequences of the set of sample data, during the application phase. The transformation that was carried out during the parameterizing phase must also take place implicitly for the observed sequence S at the same time. The method given with the following formula (11) is in a position to do this efficiently.

In principle, the method works like a digital filter. This means that a quantity giving information about the current similarity will be output for each element of the investigated sequence S. A suitable reaction can appear, if this level of similarity exceeds a given threshold. The evaluation of the sequence S is also possible synchronously to a measurement, because only the current measured value will always be needed.

The filter works as follows internally; a matrix L will be compiled and initialized with −∞ for each of the q models (see formula (6)). It will be updated with help of the formula

$$L ( i , j ) := {max}_{α = 0 , {…α}_{m} - 1} \{ \begin{matrix}L ( i - 1 , j - α ) + \\ log ( {p}_{t , i} ( α ) )\end{matrix} \} + c log ( {p}_{e , i} ( {x}_{j} ) ) \qquad ( 11 )$$

per unit of time for all i=1, . . . , N. The p_{x,i}(·) and p_{t,i}(·) probability distributions arise from the condition (10). The aₘ parameter must be selected at least so large here that p_{t,i}(aₘ)≈0 will apply to all. The c parameter serves the weighting and must be established empirically. c=1 can be selected in the simplest case. The value L(N,j) is the level of similarity searched for at the moment j, which will report how considerably the currently observed sequence resembles one of the sequences from the parameterizing phase. q of this values exist in total. The largest of these is relevant and is compared with the recognition threshold, in order to signal a recognition event in the case that it exceeds this. An implementation of L(i,j) in the form of a ring buffer is possible.

The method described above generally explains the process for pattern recognition as it can be used in different applications. Examples of applications for the use of the method of pattern recognition will now be described in closer detail in the following.

### EXAMPLE 1

One application of the method of pattern recognition is the recognition of knocking in engines; this will be dealt with in even closer detail in the following. FIG. 1 shows a schematic representation of the structure of a knocking control for an engine.

It is assumed that a sound-borne noise signal will be recorded continuously with the help of a suitable sensor and digitalized with a sufficiently high sampling rate by means of an analog digital conversion. The time signal will consequently become a sequence of scalars. This sequence will be changed into a sequence of spectral vectors (spectrogram: amplitude spectrum or energy density spectrum), which describe the form of certain frequency sections across time, by means of a STFT. The spectral vectors can subsequently be logarithmized and converted into cepstrum vectors by means of a discrete cosine transformation. However, this step is not absolutely necessary. The vector sequences will additionally be identified as sequences of feature vectors, in order to leave the actual type of pre-processing that is concluded with this out of account. The actual recognition will take place exclusively on the basis of the respective sequences of feature vectors as it has been described generally above.

A parameterization must take place before the knocking recognition is used. Sample or training data must be collected with the aid of the engine status to this end. The type of engine will be brought into the knocking and non-knocking range at different rotations and for each cylinder during this. The inner pressure of the cylinder will be measured with suitable sensors, apart from the structure-borne noise signals. This data is necessary to be able to judge clearly whether a structure-borne noise signal measured in practice corresponds to knocking or non-knocking combustion (compare FIG. 2).

The structure-borne noise signals recorded will subsequently be processed, by cutting all sections in the case of which excess pressure is present in the pressure signal measured at the same time. The knocking level of each fragment of structure-borne noise will be established in addition on the basis of the pressure signal and connected with it (labelled). The pressure signals will be band-pass filtered and rectified for this. The remaining maximum amplitude will represent a measure for the actual level of the knocking. A data set of fragments of structure-borne noise, with which it will be possible to parameterize the knocking identification, will be available after this step. The pressure signals will then no longer be needed.

Two models will be parameterized for the knocking recognition. The first model serves the identification of knocking combustion and the second to identify non-knocking combustions. The task can be attributed to a simple classification problem in this way. The fragments of structure-borne noise cut from the continuous fragments of structure-borne noise signal and labelled with the knocking level will be the starting point for the parameterization.

The model for non-knocking combustion will only be parameterized with those fragments of structure-borne noise of which the knocking level lies below a previously defined threshold ε₁. The model for the knocking combustion will be parameterized accordingly with the aid of unambiguously knocking fragments of structure-borne noise. The knocking level must exceed a threshold ε₂ for this. Both thresholds ε₁ and ε₂ can be equal. However, it is sensible to select ε₂ as somewhat higher than ε₁ in practice. Both models are otherwise completely identical, apart from the data basis used. The parameterization phases do not differ from each other either, so that it is sufficient to describe them by means of a single model.

As a rule, it is better for the pattern recognition to analyse sequences of feature vectors derived from the structure-borne noise signals, that is, successions of feature vectors, not the structure-borne noise signals directly. It is sensible to divide structure-borne noise signals into short overlapping time windows of the same length initially and to calculate the amplitudes or the energy density spectra from them respectively, as already described, in the case of this practical example. Each of these spectra can be regarded as a fixed dimension feature vector. Thus, a fragment of structure-borne noise will become a sequence of feature vectors (compare FIG. 3).

The sequences of feature vectors created by the pre-processing will also differ in length, because the fragments of structure-borne noise will differ in length. Thus, a direct comparison is not possible. A treatment of the classification problem with a classic pattern recognition method based on feature vectors is also impossible, because it is a pre-requisite that an enclosed feature space exists and that an implicit estimate of the probability distribution of the set of sample data is consequently possible.

Feature vectors, which will subsequently be used to parameterize the model as explained above, will now be formed in accordance with the method described above. Then, the model can be used to recognize patterns in the way explained above. Two of these values exist, because two models have been created during the parameterization phase, namely one for knocking and one for non-knocking combustion. There will be either knocking or non-knocking combustion according to which of these values is larger. There will be no combustion currently or the sensor is damaged, if both values are low. The engine control device consequently has the possibility to detect a failure of the knocking identification. This is important to avoid damage to the engine.

The method described enables a continuous search for knocking combustion. It must be understood by this that the method can make a criterion for the current knocking level at each sampling time available, similarly to a digital filter. No a priori guidelines beyond this are necessary and the determination of the parameters will take place mainly in a constructive way, that is, without numerical optimization.

Other problems can be attributed to a sequence recognition problem in connection with pattern recognition, as explained above in connection with knocking identification. This is explained in more detail in the following.

### EXAMPLE 2

Some of the applications are based on time signals. It is relatively obvious at which point the method for recognizing can profitably be used in the case of these applications. For example, the time signal can be used directly, in the case of the signal analysis of ECG signals (ECG—electrocardiogram). The matter then concerns the use of the method described above for automatic pattern recognition in the case of a signal analysis of ECG signals. Sequences in the ECG signals that may point to disruptions in rhythm can be established in ECG signals in this way.

### EXAMPLE 3

The application of automatic pattern recognition in connection with speech recognition is also based on time signals. It is, however, sensible to carry out a pre-processing of the time signals, which are audio signals in this specific case, in the case of speech recognition. The sound signals will be converted into the outcomes of spectral vectors, in the same way as the action described above in the case of knocking identification. The advantage of this transformation exists in that the irrelevant phases arising from the signals for physical reasons can be removed so easily. FIG. 3 therefore also applies to the application of speech recognition by machine.

The simple application of speech recognition by machine consists of recognizing individual pre-defined command words. A microphone and a microprocessor that is additionally able to memorize the analog audio signals digitally are necessary at least. It is necessary initially to record a set of sample data with the respective measuring device, in order to use the method described above for recognizing command words. At least some examples must be recorded for each command word. They will then be prepared and labelled; that means that they will be marked what command word is concerned in each specific example in a machine-readable way.

A model will now be created for each command word. The corresponding example will be pre-processed and converted to spectral vector sequences to do this. These will be the actual sequences from which the feature vectors of the same length will then be created in the way already described (Formulas (1) to (4)). The models will then be created with the help of the parameterization described (Formulas (5) to (10)). The equation (11) will then enable the use of the model created to analyse a continuous audio signal. It can be assumed that the continuously investigated audio signal currently contained a statement that was similar to the commando words that were used during the parameterization of the corresponding model, if the level of similarity continuously calculated for each model exceeds a pre-defined threshold at a certain moment. A report of the connected label will appear to the user of the system as recognition of the statement spoken and can be used to trigger particular useful actions.

### EXAMPLE 4

The patterns to be searched for consist of certain significant fragments of code, therefore successions or sequences of bytes describing the behaviour of the code, in the case of a virus scanner. Variations of certain parts of the code, which do not change the actual behaviour, although they lead to a changed byte sequence, are frequently inserted, so that viruses are not so easy to find. For example, NOP (No Operation) machine commands may be inserted at any points of the code. Other code sequences that have no ultimate effect may also be inserted.

The procedure for finding damaging program code with the aid of the method described above consists in describing the byte sequences of different changed versions by a common model and in searching for them after the occurrence of the virus. The byte sequences of Formulas (1) to (4) will be transformed correspondingly to feature vectors of a fixed length to do this. The parameterization of the model follows directly. This then concerns a use of the method described above for automatic pattern recognition during virus scanning.

### EXAMPLE 5

The search for genes or similar genes in DNA sequences is a very similar problem. Sequences of amino acids are searched for in this case, instead of byte sequences. The matter then concerns the use of the method described above for automatic pattern recognition (gene sequences) during an analysis of gene sequences, where a gene sequence represents the sequence of electronic data.

### EXAMPLE 6

The use of the method in image analysis is not quite so obvious, because there are two-dimensional data structures there. The nature of some of these tasks can be attributed to a problem in sequence analysis. For example, a hand-written text can be interpreted as a sequence or succession of X-Y co-ordinates. However, these sequences cannot be compared directly, as a consequence of varying writing speeds. Nonetheless, the invention offers a direct possibility to process such data. For example, the nature of the task could exist in checking the signature or autograph of an individual, in order to carry out the authentication of a laptop, for example. The necessary hardware, a touch pad and a computer for the evaluation is already included in the devices.

Each sequence will start when tap on the touch pad is registered and will end if no further touch has been received for a certain time. The first co-ordinate of the sequence can be subtracted from all the remaining co-ordinates of the sequence, so that the position at which the signature or autograph has been written does not exert any influence. It will be ensured that each sequence of co-ordinates begins at the origin (0,0) in this way.

Some examples, from which the feature vectors of fixed length will then be created in accordance with Formulas (1) to (4), will be needed to be able to recognize the signature or autograph of an individual now. The model will then be parameterized (Formulas (5) to (10)) on this basis. The model can be used to compare all the sequences of co-ordinates received with the model stored either continuously or only on request, after it has been parameterized. Formula (11) can be used for this.

### EXAMPLE 7

Time signals that can be interpreted directly as sequences, namely courses of electricity or voltage, are frequently used in the case of machine signal analysis. Other sensor data where a malfunction takes place because of transmission functions can be investigated in the form of spectrograms (compare knocking identification above). Many applications decidedly exist where the sequence recognition can be used sensibly exist as a rule in engineering and plant engineering. However, it is typical in this case that it almost always concerns a specified problem, a part of a control, of a process monitoring system or similar, for example. In that case, the matter concerns a use of the method described above for automatic pattern recognition during the control or process monitoring of a machine or a plant, where the sequence of electronic data represents data for the control or the process monitoring system, where associated sample or training data will have been collected previously.

### EXAMPLE 8

The evaluation of heat image data for the quality control in the case of machine made components is a further application of the pattern recognition method. Forged parts may exhibit cracks. The cracks can mostly not be recognized well by purely visual means. Certainly, the respective behaviours of areas with and without cracks deviate from each other. Images of the forged components are briefly taken by means of a heat image camera, in order to be able to record such deviations. The cooling of a component will correspond to a change in a grey-tone grey value image G(x,y,t) made by the heat image camera through a period t. The image co-ordinates x and y (pixels) will be allocated to a respective area of the surface of the component, because the position of the component in relation to the heat image camera does not change during the shot. The temporal behaviour of the grey scale value can be described approximately by a diminishing exponential function here:

G(x,y,t)≈G(x,y,0)·exp(−l(x,y)·t)

The l(x,y) parameter can preferably be assessed by linear regression. Additional parameters describing the cooling are possible. A V(x,y) parameter co-ordinate, which is only one-dimensional in the simplest case, will be formed for each x and y image: V(x,y)=l(x,y) will be formed for each x and y image co-ordinate in this way.

The result of this pre-processing can be represented as a halftone picture (one-dimensional parameter vector) or as a false-colour image (multi-dimensional parameter vector), because each x and y image co-ordinate is allocated precisely to one V(x,y) parameter vector. A deviating cooling behaviour in such V(x,y) secondary images is immediately apparent visually as an unusual discolouring. However, it is disturbing for a mechanized evaluation that the position and the components vary from case to case in the secondary image. This variation has technical processing reasons and mainly becomes apparent as a horizontal shift or distortion. A simple comparison with a reference image is not possible for this reason.

On the other hand, it is possible to interpret each Sp(x)=(V(x,1),V(x,2),V(x,3), . . . ) column of the V(x,y) secondary image as a vector. The sequence of the S(x) columns from right to left will then form a succession of S=Sp(1),Sp(2),Sp(3), . . . vectors and consequently a sequence. The nature of the task of finding the position of the component and the comparison with a reference is consequently reduced to a problem of recognizing a sequence, which can be solved with the pattern recognition method in accordance with the invention. The reference image (reference) will be formed from several sample sequences from error-free components, by means of the method in accordance with the invention, for example.

All in all, a method for automatic pattern recognition that can be used in many different applications, because corresponding electronic data containing information allocated to the respective application is analysed in the way explained above, is described above. The starting point of the method here is initially the creation of a set of feature vectors of the same length or dimension from training or sample data by means of a dynamic time warping method. Feature vectors that can then be investigated to recognize the pattern with the help of any classifiers in principle are created in this way. A neural network (e.g. a multi-layer Perzeptron) could also be used, for example (Bishop: Neural networks for Pattern Recognition, Clarendon Press, Oxford, 1995). Many other classifiers, such as supporting vector machines, polynomial classifiers or a decision tree method are also possible (Niemann: Klassifikation von Mustern, 1995). Certainly, all classifiers that carry out the necessary equalization of the observed sequences efficiently during the application phase must solve the problem as well. None of the methods specified is able to do this in its basic form.

The creation of feature vectors represents an independent aspect of the invention that unfolds its advantages, independently of the subsequent selection of the classifier and consequently in combination with the most varied classifiers, independently of the subsequent version of the classification method.

The method for automatic pattern recognition described can be used advantageously for automatic pattern recognition, particularly in connection with the following applications: speech recognition by machine, recognition of hand-writing, analysis of gene sequences, search for damaging program code (virus scanner), medical technology applications such as heart pacemakers or electrocardiograms and diagnosis applications by machine such as knocking identification.

The features disclosed in at least one of the specification, the claims, and the figures may be material for the realization of the invention in its various embodiments, taken in isolation or in various combinations thereof.

1. A method for automatic pattern recognition in a sequence of electronic data by means of electronic data processing in a data processing system, where the sequence of electronic data is compared in an analysis with parameterized model data representing at least one pattern sequence in an analysis and where at least one pattern sequence will have been recognised, where the training data is processed to a set of feature vectors of equal length and the same content as the training data, from which the parameterised model data has been derived, by means of a dynamic time warping method, during the formation of the parameterized model data, if it has been established during the analysis that the model data enclosed by the parameterised model data allocated to at least one pattern sequence occurs with a level of similarity exceeding the similarity threshold.

2. The method in accordance with claim 1, characterised in that the parameterised model data are derived from the set of feature vectors, by parameterizing a feature vector classifier.

3. The method in accordance with claim 2, characterised in that a Bayes classifier with Parzen window density estimation is used.

4. The method in accordance with claim 1, characterised in that the level of similarity L(N,j) for a point in time j of the analysis, for the partial sequence of electronic data from the sequence of electronic data, is established as follows:
$$L ( i , j ) := {max}_{α = 0 , {…α}_{m} - 1} \{ L ( i - 1 , j - α ) + log ( {p}_{t , i} ( α ) ) \} + c log ( {p}_{e , i} ( {x}_{j} ) )$$
where xⱼ, p_{t,i}(·) and p_{e,i}(·), the elements of the sequence of electronic data, the i elements of al N elements of parameterised model data and c and aₘ, are constants to be selected empirically.

5. A device for automatic pattern recognition in a sequence of electronic data by means of electronic data processing, by a data processing system having the following characteristics:
pattern recognition means that is configured to compare the sequence of electronic data with parameterised data in an analysis and to recognise at least one pattern sequence, if it has been established during the analysis that the model data enclosed by the parameterised model data allocated to at least one pattern sequence occurs with a level of similarity exceeding the similarity threshold and
model data creation means configure to create the parameterised model data using training data and to process the training data to a set of feature vectors of the same length and with the same information content as the training data from which the parameterised model data has been derived by means of a dynamic time warping method and
provision means configured to provide electronically assessable identification information by recognising at least one pattern sequence for an output.
